(19) United States
(12) Patent Application Publication
(10) Pub. No.: US 2006/0085491 A1
(43) Pub. Date: Apr. 20, 2006

(54) System and method for recovering from interruptions during data loading

(76) Inventors: Jane E. Foote, Novi, MI (US); David Steinhoff, Ann Arbor, MI (US); Mark Welter, Pinckney, MI (US)

Correspondence Address: PILLSBURY WINTHROP SHAW PITTMAN, LLP, P.O. BOX 10500, MCLEAN, VA, 22102, US

(21) Appl. No.: 11/246,530

(22) Filed: Oct. 11, 2005

Related U.S. Application Data
(60) Provisional application No. 60/616,836, filed on Oct. 8, 2004.

(51) Int. Cl. G06F 17/30

(52) U.S. Cl. 707/202

(57) ABSTRACT

One aspect of the invention relates to a system and method for quickly and efficiently recovering from an interruption that occurs when modifying and loading a dataset. One or more editions of the dataset may be created prior to performing a modification to files. These editions may include one or more of a draft edition, an approved edition, and/or other editions. A draft edition may be an edition of a database or dataset, wherein a dataset may be its own database. The draft edition may be used for implementing desired changes. An approved edition may be implemented for storing changes a user may want to keep safe before publishing the changes made in the draft edition. A published edition may be implemented to allow authorized users to view published data. Modifications are made to the draft edition, protecting the integrity of the published dataset editions and/or other editions.

### CROSS-REFERENCE TO RELATED APPLICATIONS

This application claims the benefit of U.S. Provisional Application entitled “Interruptability for Data Loading”, No. 60/616,836, filed Oct. 8, 2004.

### FIELD OF THE INVENTION

The invention relates to recovering from data interruption when modifying data or metadata in a dataset by creating multiple editions of the dataset.

### BACKGROUND OF THE INVENTION

It is well known that various factors can cause a dataset to become unstable and/or unusable if an interruption occurs during a data loading or modification process. The interruptions can include system failure, power loss and various other types of interruptions. In many cases, if a dataset was in the process of being loaded or modified during the interruption it is difficult to recover from that partial completion of the modification. In many cases, if an interruption occurred when a dataset was in the process of being modified, it is difficult to recover from that partial completion of the modification. Other problems arise when applications are running against a dataset that is being modified. Various other data integrity problems arise in this context and are well known.

### SUMMARY OF THE INVENTION

One aspect of the invention relates to a system and method for quickly and efficiently recovering from an interruption that occurs when modifying and loading a dataset. End users typically access a published edition of a dataset. Various embodiments of the invention create one or more other editions of the dataset prior to performing a modification to any of the files. These editions may include one or more of a draft edition, an approved edition, and/or other editions. A draft edition may be an edition of a database or dataset, wherein a dataset may be its own database. The draft edition may be used for implementing desired changes and/or act as a preliminary version of a dataset (database). An approved edition may be implemented for storing changes that a user may want to keep safe before publishing the changes made in the draft edition. A published edition may be implemented to allow authorized users to view published data. Modifications are made to the draft edition, protecting the integrity of the published dataset editions and the approved dataset editions and/or other editions, if any exist.

According to further embodiments of the invention, other dataset (or database) editions may be created in addition to the published, draft, and approved editions. For example, a user may create multiple published editions. Alternatively, less dataset editions may be implemented. In still further embodiments, end users may be able to access draft and/or approved editions.

Modifications may be approved before publishing a dataset. An approved edition of the dataset may be created from a draft edition. If an interruption occurs after an approved edition of a dataset has been created, the user may be able to recover the modifications that have been approved.

According to various embodiments of the invention, each edition of a dataset has a corresponding view file, also referred to as an edition metadata file. The view file (edition metadata file) includes the list of files which make up that edition of the dataset. The view file may also include information for one or more files in the list. This information may include a logical filename, a physical filename, a flag indicating whether the file is owned by the view, a flag indicating whether a file that was in an earlier view (such as the published or approved view) has been deleted, and other information. Each of the editions of the dataset may be represented by a corresponding view file (edition metadata file). Ownership allows a file to be modified. For example, ownership of a file may be established in order for modification to be made in a draft edition. Ownership may not be as relevant for a published edition and/or approved edition since modification are usually not made within these editions.

A draft edition of the dataset may be created from the published, approved, or other edition of the dataset. This may be done for example, by copying a view of the desired edition as a new draft view file (edition metadata file) and modifying the ownership flag. For example, a flag for a published, approved, or other view file (edition metadata file) may indicate that the corresponding dataset edition owned all of the files in its edition. A flag corresponding to the new draft view created from it may indicate that the draft edition does not initially own any of the files in the draft edition.

Various aspects of these views may be modified, edited, updated, etc., depending upon the actions taken or actions pending with regard to the files in the respective edition. For example, in order to modify a file in the draft edition, a new version of the file may be created. The new versions may be owned by the draft edition rather than a previous edition. The new version of the file replaces the old one in the draft view file (edition metadata file). Files that are modified or added in the draft edition are reflected in the draft view file as owned by the draft edition, while files that have not been changed are reflected as owned by another view file. Before a file can be edited, the draft view file may have to own the file. Because the draft view is copied from the published, approved or other view, the system updates the ownership flag for each file as it is modified, edited, or otherwise changed. Setting the ownership flag to indicate ownership by the draft view file indicates that the draft edition owns the latest version of the file.

An approved edition of the dataset may be created by copying the draft view. When an approved edition is created from the draft view, all files are set to be owned by the approved view. The corresponding draft view may then be automatically deleted, marked old, or tagged for deletion. Additional changes may be made by creating a new draft view from the approved view. If the additional changes are later approved, then a new approved view may be created from the draft view. This new approved view supersedes the previous approved view, and may include all changes that were in the previous approved view. The previous approved view may be deleted and/or marked as old and the draft view may also be deleted and/or marked as old.

Various embodiments of the invention may include a data loader for creating and modifying datasets that may be used by one or more applications. The data loader may recover from interruptions occurring during a task by operating as a state machine. Each operation may have one or more entry states, a known sequence of states arrived at by state transition operations, and a completion state. When the data loader starts after an interruption, it determines what state the dataset is in. From there, the sequence of states may be restarted. Tasks may include, for example, adding a dataset, deleting a dataset, modifying a draft, publishing changes, approving changes, discarding changes, and other tasks. Some tasks may be restarted after an interruption. Modifying a draft edition may not be restarted, but only the draft edition is lost after an interruption; the approved published and other editions are not lost.

Some state transitions include a single atomic operation. Operations that are interrupted during an atomic state transition may be restarted, since the next state and transition to that state is known. Some state transitions are non-atomic and may not be restarted. These non-atomic state transitions may include multiple steps. If the last step before the data loader was interrupted is a non-atomic state, the data loader may operate as if that step only partially completed, and redo the non-atomic step.

According to various embodiments of the invention, it may be desirable to stop applications that are running against a published dataset before a modified dataset is published. Users may be notified that the dataset will be unavailable and may receive a request to discontinue the application. According to some embodiments of the invention, users connected to a dataset while a publishing operation occurs may continue to use the dataset. That edition of the dataset may be considered an obsolete edition, and the user may continue using this edition until they log out of the application. According to some embodiments of the invention, the system may prevent a new start of an application against obsolete data. A user requesting an obsolete data edition may receive a notification that the dataset is temporarily unavailable.

These and other objects, features, and advantages of the invention will be apparent through the detailed description and the accompanying drawings. It is to be understood that both the foregoing general description and the following detailed description are exemplary and not restrictive of the scope of the invention

### BRIEF DESCRIPTION OF THE DRAWINGS

FIG. 1 illustrates a block diagram of aspects of the invention, according to an embodiment of the invention.

FIG. 2 illustrates a flowchart for an operation involving multiple dataset (database) editions, according to an embodiment of the invention.

FIG. 3 illustrates a state diagram for adding and deleting a dataset, according to an embodiment of the invention.

FIG. 4 illustrates a state diagram for modifying a dataset, according to an embodiment of the invention.

FIG. 5 illustrates a state diagram for approving and publishing changes, according to an embodiment of the invention.

FIG. 6 illustrates a state diagram for discarding changes to a dataset, according to an embodiment of the invention.

### DETAILED DESCRIPTION OF PREFERRED EMBODIMENTS

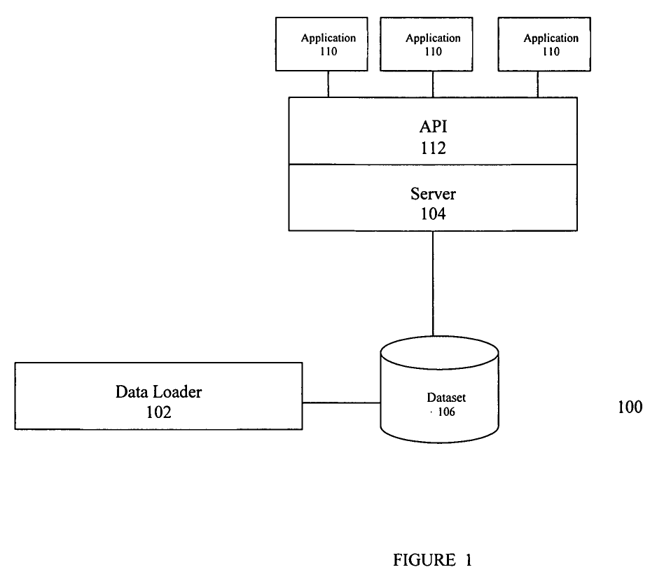

FIG. 1 illustrates a system 100 according to various embodiments of the invention. System 100 may include a server 104, which maybe software that uses datasets stored in dataset 106. Data loader 102 may create and modify datasets stored in dataset 106. Each dataset 106 may also be its own database. Applications 110 may connect to server 104 to interact with dataset 106 via application program interface 112.

Server 104 may be or include, for example, software running on a workstation, such as a workstation running Microsoft Windows NT, Unix, Novell Netware, and/or other operating systems. While illustrated as being directly connected via API 112 to server 104, applications 110 may be remotely located and may access server 104 across one or more networks. The server 104 may analyze data of the dataset (database) in a read-only manner. The API 112 associated with the server 104 may allow the various applications 110 to access the dataset in a read-only manner via the server 104. Networks may include, for example, the Internet, an intranet, and/or other networks.

To prevent data loss or corruption in the event of an error in loading data, data loader 102 may create one or more editions of a dataset. In one example, one or more editions of a database (dataset) may be created within a single database (dataset). A view file also referred to as an edition metadata file may also be created corresponding to each database (dataset) edition. The view file (edition metadata file) may include a list of the files which make up that edition of the dataset (database). The view (edition metadata) may provide a mapping of logical to physical file names. Views (edition metadata) will be described in further detail hereinafter. Dataset editions may include, for example, one or more of a published edition, a draft edition, an approved edition and/or other editions.

End users typically access a published edition of a dataset. The published edition may be used to maintain stable data in the event of an interruption to data loader 102. The published edition may remain unchanged when modifications to the data are performed. Instead, a draft edition of the published edition may be created, and used for modifications.

A draft edition may be created for modifying a desired dataset. Any changes to the dataset may be made using the draft edition, thus protecting the published edition from data loss. The draft edition may be created by first making a copy of the published, approved, or other edition. These changes may be discarded, published, or approved. If an interruption occurs while a draft is being modified, the draft edition becomes unstable. The unstable draft edition may be discarded. A new draft may be created after the interruption by copying the corresponding published, approved, or other edition, if one exists.

An approved edition may be used for storing changes that a user wishes to keep safe before publishing the changes. An approved edition may not be edited directly, and may be created from a draft edition. This may cause the draft edition to be deleted and/or marked as old. If an interruption occurs and an approved edition exists, the approved edition remains unaffected. If additional modifications are required after an approved edition has been created, a new draft edition may be created from the approved edition to accept the modifications.

As previously described, each edition of a dataset has a corresponding view also referred to as edition metadata. The view file may also be referred to as edition metadata file corresponding to each edition. A view file (edition metadata file) of a dataset may include a list of files which make up each edition of the dataset. The list of files may include information indicating, for example, the logical name of each file, the physical name of each file, whether the file is owned by the edition, whether a file that was in a previous edition has been deleted, and other information. An edition may own a file if the file was created under that edition. When a file is created, the view file (edition metadata file) may have to indicate that it owns the file. If a request is made to modify a file, data loader 102 may first determine if the view owns the file for which a modification is desired. If not, a new physical file may be created and modified.

Ownership allows a file to be modified. For example, ownership of a file may be established in order for modification to be made in a draft edition. Ownership may not be as relevant for a published edition and/or approved edition since modification are usually not made within these editions. For example, when a user wishes to make modifications to a file within the view file (edition metadata file) of a published or approved edition, a new physical copy of the file may be created for the draft edition. This usually means that the view file will be updated to include the new file in the list of files. The draft edition will also receive ownership of the newly created file. If at a subsequent time the same file needs to be modified, the user may simply refer to the file already owned in the list without having to go through the copying procedure again.

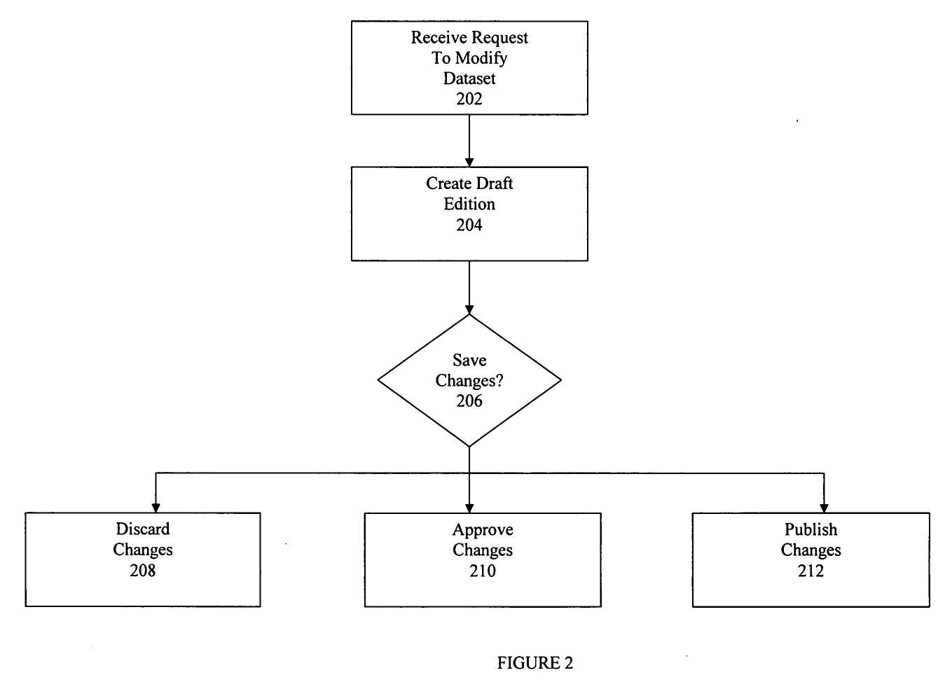

FIG. 2 illustrates a set of operations that may occur for a dataset having three views: a published view, an approved view, and a draft view. These views may also each be referred to as published edition metadata, approved edition metadata, and draft edition metadata. Views (or edition metadata) may be implemented in separate files. Initially, only the published view (edition metadata) exists. A request may be received to modify the dataset (or database), as illustrated at operation 202. Before changes are made to the dataset, a draft edition may be created by copying the published view to a draft view, and the changes may be applied to the draft edition and view, as illustrated at operation 204. Subsequent changes continue to be applied to the draft edition until the user wishes to save or discard them. Throughout this editing, the published view and its files are unaffected. Even if errors occur in changing the draft view, leaving its data in an unusable state, the published view, being unchanged, would continue to be usable. Once all desired changes have been made, a user may decide what should be done with the changes, as illustrated at operation 206. The user may wish to discard the changes, as illustrated at operation 208, approve the changes, as illustrated at operation 210, or publish the changes, as illustrated at operation 212.

If the user wishes to save the changes, the user may choose to approve the changes, as illustrated at operation 210. Approving the changes may create an approved view from the draft view, and may discard the draft view. If additional changes are required after changes have been approved, a new draft view may be created from the approved view. Approving changes made in the new draft view may cause a new approved view to be created, and may also cause the new draft view and the old approved view to be deleted and/or marked as old. The user may also choose to save the changes by publishing the data, as illustrated at operation 212. Publishing data makes the data available to all authorized users. The user may publish the data directly from the draft view, or may publish changes from the approved view. When choosing operation 208 to discard changes, the user may be presented with the option to discard unapproved changes or to discard draft and approved changes.

According to various embodiments of the invention, interruptibility may be implemented by operating data loader 102 as a state machine. Each task may have one or more entry states, a known sequence of states arrived at by state transition operations, and a completion state. When data loader 102 starts after an interruption, it determines what state the dataset is in. From there, the sequence of states may be restarted for most operations.

Transition between states may involve a single atomic operation, such as, for example, deleting a single file or creating an empty file. When performing a non-atomic operation, a file having a “.cdlop” (or other) extension may be initially created. This file may be created as a first atomic step, indicating which state transition is in progress. The file may be deleted as the last atomic step in the state transition. If an interruption occurs during a single operation, the next state may easily be determined. Either the operation has completed or the operation did not complete, and the operation may easily resume at the next state. Other operations are non-atomic and involve a series of steps, such as, for example, creating a file or writing to a complex file. If an interruption occurs during an operation involving a series of steps, data loader 102 may repeat several or even all of the steps in the sequence upon restarting.

Creating a file and writing contents to it is a non-atomic operation. Any time data loader 102 needs to create a file and write to it, it may first create the file with an additional “.cdltmp” (or other) suffix. Next, data loader 102 may write the contents of the file, and if the writing is completed successfully data loader 102 may rename the file to its desired name (i.e. remove the .cdltmp suffix and possibly insert a timestamp). In other embodiments, the file may be renamed upon completion of the operation. In this way, any time a data loader operation is restarted, the presence of a file that ends in “.cdltmp” indicates not only what stage of the operation was interrupted, but also that the file is incomplete and should be emptied and rewritten.

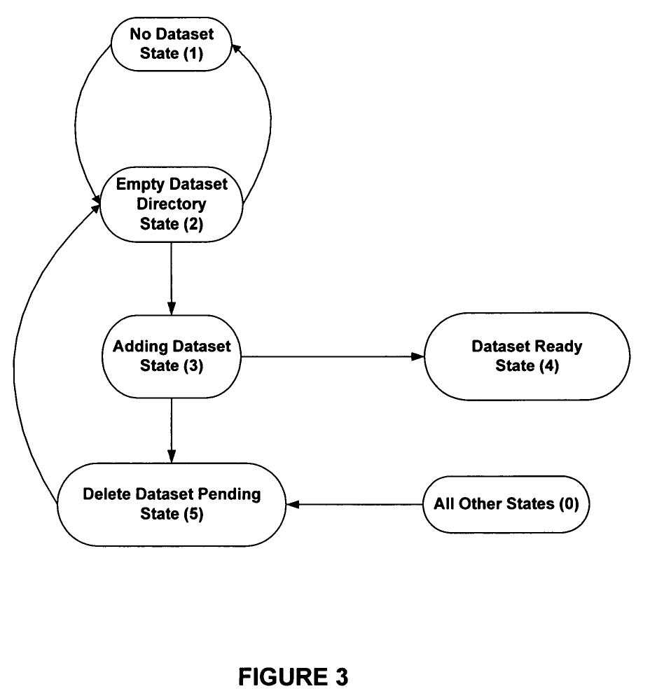

FIG. 3 illustrates a state diagram for adding and deleting a dataset. Adding a dataset may begin in a first state 1, where no dataset directory currently exists. A transition may be taken to state 2, by creating an empty dataset directory. The transition from state 1 to state 2 is an atomic transition. From state 2, the add dataset task transitions to state 3 indicating that the operation is in progress. This transition is performed by creating an empty “addingDataset.cdlop” file. The transition from state 2 to state 3 is also an atomic transition. To complete the task, a transition may be made to state 4, at which point the dataset is fully created, that is, the dataset is ready. The transition to state 4 is non-atomic. It may include creating a view list file also referred to as edition list file, and published view file and other dataset files and directories Non-empty files that are created are first created with a cdltmp extension, and only after such a file's contents are complete is the file renamed to its final name (without the cdltmp extension). The last step in the transition to state 4 is the deletion of the addingDataset.cdlop file.

If the loader is interrupted while in state 4, and it is restarted, it is able to tell which atomic steps were completed (such as creating a directory), and complete the rest of the atomic steps. It is able to tell which non-atomic steps are completed, such as creating a non-empty file, by looking for files of the right name; any file which was interrupted in its creation will have an extension of cdltmp. Files with extension cdltmp are deleted and re-created when restarting the Add Dataset action after an interruption.

According to some embodiments of the invention, data loader 102 may restart at an intermediate step as a result of an interruption. For example, if data loader 102 finds a view file having a “.cdltmp” extension, that unfinished view file may be deleted, and the task of creating that view file may be repeated beginning with the creation of an empty view file having a “cdltmp” extension. However, in other embodiments, the process may restart from the beginning of the operation in which the creation of the view file was only one step among several.

If the user wishes to delete a dataset, this operation may be called from any state. This is illustrated in FIG. 3 as state 0. Unless the delete dataset operation is called from an interrupted add dataset or delete dataset operation, at least one view list file will exist in the data set. Deleting a dataset takes the dataset through 4 states: the initial state 0, the Delete Dataset Pending state 5, the Empty Dataset Directory state 2, and the final No Dataset state 1. From the initial state, state 5 is reached by the atomic operation of creating an empty file named “deletingDataset.cdlop”. The transition from state 5 to state 2 is non-atomic. During this transition, first all files and directories in the dataset folder, except “deletingDataset.cdlop”, are deleted. Last, “deletingDataset.cdlop” is deleted. The transition from state 2 to state 1 is the atomic deletion of the dataset directory itself. If an interruption occurs, the task restarts in state 5, it continues deleting files. For example, if a view file exists, the task deletes it and continues processing.

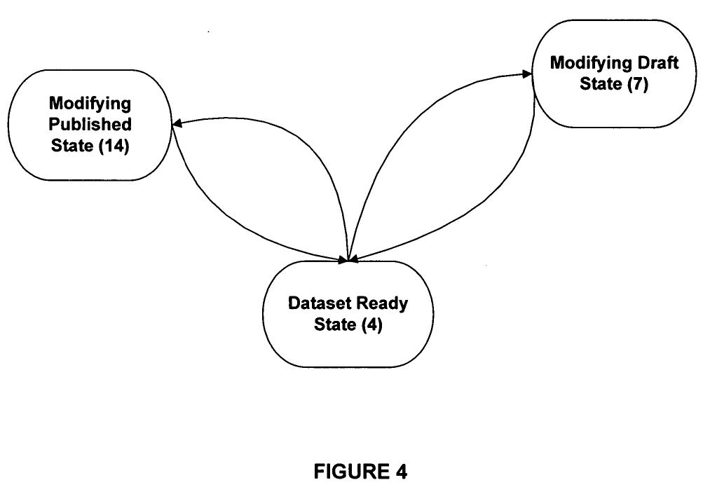

FIG. 4 illustrates a process for modifying a dataset. Modifying begins in state 4, dataset ready, and transitions to state 7 where the modifications are performed. A transition may then be made back to state 4. At the beginning of a modify draft operation, the dataset transitions from state 4 to state 7 by the atomic creation of the empty “modifyingDraft.cdlop” file. During modification, that process remains at state 7 and automatically transitions back to state 4 when complete, by deleting “modifyingDraft.cdlop”. An interruption during state 7 may result in a corrupt draft edition. An initial step in modifying a dataset may be the creation of a draft view file, if one does not exist. If later data loader 102 starts a command, including an attempt to restart a previous modify draft operation and finds the system in state 7, an error may be issued indicating that data loader 102 was interrupted while modifying the draft, the draft is corrupt, and the user should initiate a discard changes operation. A new draft may be created the next time the modify draft operation is called. Some users may want to run data loader 102 in a non-interruptible mode without the extra disk space that multiple editions of a dataset entail. A “modify published” operation and state 14 may be provided. During a modify published operation, if data loader 102 is interrupted, the dataset may be presumed to be corrupt.

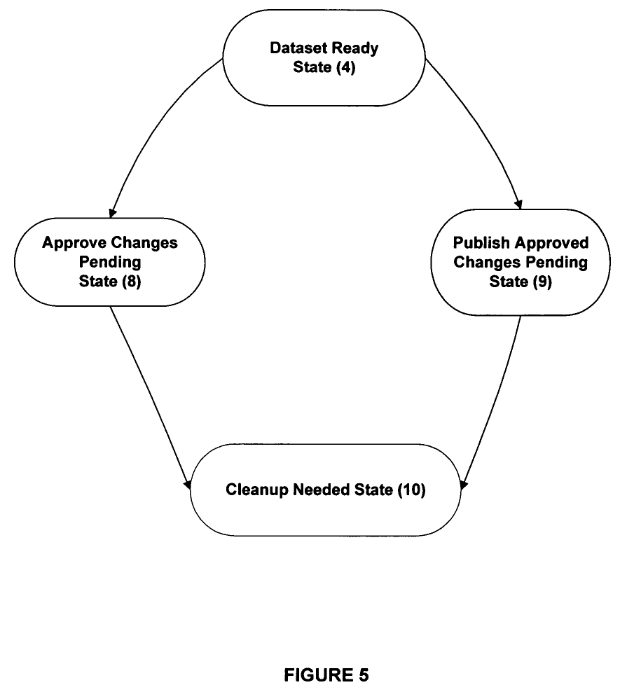

Changes to a dataset may be approved prior to publishing. FIG. 5 illustrates a state diagram for approving and publishing approved changes. An approve changes operation begins in state 4, where the dataset is in ready mode. A test may be performed to determine if changes have been made to the draft edition. If there are no changes or no draft edition, data loader 102 may exit with a warning that there are no changes to approve. If there are changes to approve, a transition may be made to a state 8, wherein the approval is pending, then to a state 10 to perform a cleanup operation, and back to state 4 wherein the dataset is once again ready. Restarting an approve changes operation before an approved changes file (approvingChanges.cdlop) is written starts the process again. Restarting an approve changes operation that was interrupted after the file is written starts in state 8. A temporary approved view file may be created from the draft view file. A temporary view list file is created. The temporary files may then be renamed to their final names when they are complete. The final step in the transition to state 10 is the deletiong of the “approvingChanges.cdlop” file, indicating that the approval is completed.

Publishing approved changes may begin in state 4, where a test is performed to determine the existence of changes in the approved view. If there are no approved changes, data loader 102 may exit with a warning indicating that there are no approved changes to publish. If there are changes to publish, a transition may be made to state 9, wherein the publishing is pending. This transition atomically creates an empty “Publishing Approved Changes” file. From state 9, a transition may be made to state 10 for cleanup. Cleanup may remove any unnecessary files. For example, once the changes have been published, any approved views may be discarded. During this transition, a temporary published view file may be created from the approved view file. The temporary suffixes may then be removed.

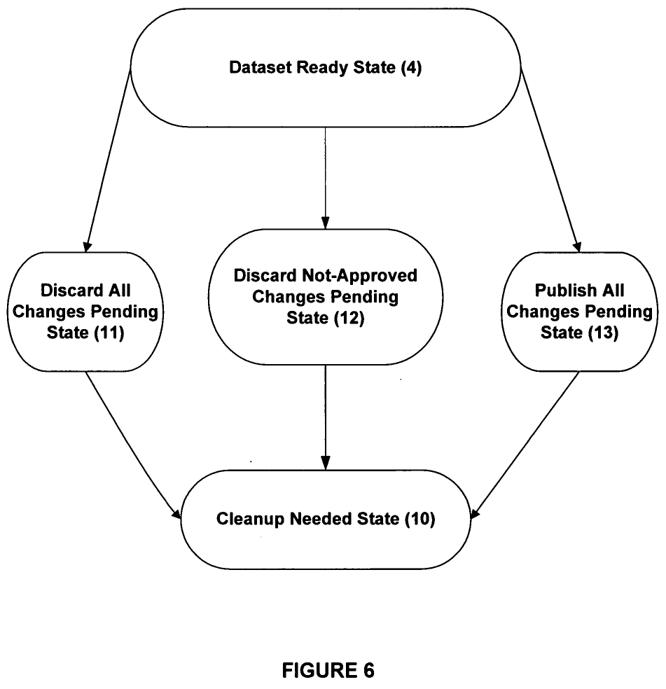

FIG. 6 illustrates other operations that may be performed, beginning at state 4, dataset ready. An operation to publish all changes may be performed, as illustrated by the transition from state 4 to state 13, and then to cleanup needed state 10. A test may be performed to determine the existence of changes in the draft or approved view. If there are no changes, data loader 102 may exit with a warning indicating that there are no changes to publish. Options may also be presented for discarding all non-approved changes and discarding all changes, as illustrated by transitions to states 12 and 11, respectively. Discarding non-approved changes tests for changes in the draft view, while discarding all changes test for changes in both the approved and draft views. Each of states 11, 12, and 13 complete by transitioning to cleanup needed state 10, which deletes obsolete views and other obsolete files.

According to various embodiments of the invention, it may be desirable to stop applications that are running against a published dataset before a modified dataset is published. The user may receive a warning indicating that the data from the dataset will not be available and requesting that the user stop using the application. In other embodiments, a user may continue to use the dataset even while a publication is being performed. This edition of the dataset may be considered obsolete. Once the user logs out of the obsolete dataset and restarts, that user may be presented with the newly published data. According to various embodiments of the invention, data loader 102 may detect when a last user has completed the use of an obsolete data edition. This may enable data loader 102 to delete the obsolete edition and provide additional disk space. Users may be notified of the newly published data, for example, through a pop-up window, an email, and/or other notification methods. New users may be prevented from requesting an obsolete dataset edition. The user may receive a notification indicating that the dataset is temporarily unavailable. Other dataset editions may be created in addition to the published, draft, and approved editions. For example, a user may create multiple published editions. This may enable end users to view more than one edition of a dataset.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims.

What we claim is:

1. A computer-based method for recovering from errors that occur when editing a database comprising the steps for:
creating at least a first edition and a second edition of the database and an edition metadata file corresponding to each edition of the database, wherein the edition metadata file includes a list of one or more files that make up the edition of the database;
selecting a file to modify from the one or more files that make up the edition metadata of the database;
copying the selected file of the one or more files to a new file in the second edition of the database;
making modifications to the new file.

2. The computer-based method of claim 1, wherein the step for copying the file further includes updating a second edition metadata to include the new file in the list of one or more files corresponding to the second edition of the database.

3. The computer-based method of claim 1, wherein the step of making modification further includes setting an ownership flag in the selected file and new file to indicate the second edition as the owner.

4. The computer-based method of claim 1, wherein an edition list file for the database lists the editions and the corresponding edition metadata files for each edition.

5. The computer-based method of claim 1, wherein the edition metadata file includes one or more of a logical file name, physical file name, ownership flag, and a delete flag for one or more of the list of one or more files that make up the edition of the database.

6. The computer-based method of claim 1, further including the step for creating a third edition of the database and a corresponding third edition metadata file, wherein the third edition of the database stores the new file with the modifications.

7. The computer based method of claim 6, wherein the new file in the second edition of the database includes one or more of: marking the file as old, deleting the file, and marking the file for deletion.

8. The computer-based method of claim 1, further including the step for saving the new file with the modifications to the first edition of the database.

9. The computer-based method of claim 8, wherein the new file in the second edition of the database includes one or more of: marking the file as old, deleting the file, and marking the file for deletion.

10. The computer-based method of claim 4, wherein an edition is deleted by deleting the edition metadata file and the edition from the edition list file.

11. The computer-based method of claim 1, wherein the first edition is published edition and the second edition is draft edition.

12. The computer-based method of claim 6, wherein the third edition is either an approved edition or a more recent published edition.

13. The computer-based method of claim 1, further including the step for recovering to a first edition of the selected file if an error occurs when modifying the new file.

14. A computer-based system for recovering from errors that occur when editing a database comprising:
a data loader creating at least a first edition and a second edition of the database and an edition metadata file corresponding to each edition of the database, wherein the edition metadata file includes a list of one or more files that make up the edition of the database;
the data loader selecting a file to modify from the one or more files that make up the edition metadata of the database;
the data loader copying the selected file of the one or more files to a new file in the second edition of the database;
a data loader application making modifications to the new file.

15. The computer-based system of claim 14, wherein the data loader having means for updating a second edition metadata to include the new file in the list of one or more files corresponding to the second edition of the database.

16. The computer-based system of claim 14, wherein the data loader having means for setting an ownership flag in the selected file and new file to indicate the second edition as the owner.

17. The computer-based system of claim 14, wherein an edition list file for the database lists the editions and the corresponding edition metadata files for each edition.

18. The computer-based system of claim 14, wherein the edition metadata file includes one or more of a logical file name, physical file name, ownership flag, and a delete flag for one or more of the list of one or more files that make up the edition of the database.

19. The computer-based system of claim 14, wherein the data loader having means for creating a third edition of the database and a corresponding third edition metadata file, wherein the third edition of the database stores the new file with the modifications.

20. The computer based system of claim 19, wherein the new file in the second edition of the database includes one or more of: marking the file as old, deleting the file, and marking the file for deletion.

21. The computer-based system of claim 14, wherein the data loader application having means for saving the new file with the modifications to the first edition of the database.

22. The computer-based method of claim 21, wherein the new file in the second edition of the database includes one or more of: marking the file as old, deleting the file, and marking the file for deletion.

23. The computer-based system of claim 17, wherein an edition is deleted by deleting the edition metadata file and the edition from the edition list file.

24. The computer-based system of claim 14, wherein the first edition is published edition and the second edition is draft edition.

25. The computer-based system of claim 19, wherein the third edition is either an approved edition or a more recent published edition.

26. The computer-based system of claim 14, wherein the data loader having means for recovering to a first edition of the selected file if an error occurs when modifying the new file.

27. A computer-based system for recovering from errors that occur when editing a database, comprising:
a data loader operating as a state machine, wherein a task performed by the data loader on a database has an entry state, a sequence of states including state transitions, and a completion state.
the data loader determining which state of the task the data loader was last operating after an error occurs when performing the task;
the data loader restarting the task from the determined state.

28. The computer-based system of claim 27, wherein the sequence of states includes creating a state file for each state transition, the state file having a temporary name until the state transition is complete; the data loader renaming the state file after the state transitions is complete.

29. The computer-based system of claim 27, wherein the determined state is based on the state file name.

30. The computer-based system of claim 29, wherein the task includes one or more of: adding a dataset, deleting a dataset, modifying a draft, publishing changes, approving changes, and discarding changes.

31. A computer-based method for recovering from errors that occur when modifying a database, comprising the steps for:
performing a task on the database, wherein the task comprises an entry state, a sequence of states including state transitions and a completion state;
determining which state of the task was last performed after an error occurs when performing the task;
restarting the task from the determined state.

32. The computer-based method of claim 31, wherein the sequence of states includes creating a state file for each state transition, the state file having a temporary name until the state transition is complete, the data loader renaming the state file after the state transitions is complete.

33. The computer-based method of claim 32, wherein the determined state is based on the state file name.

34. The computer-based method of claim 33, wherein the task includes one or more of: adding a dataset, deleting a dataset, modifying a draft, publishing changes, approving changes, and discarding changes.
